(19) United States
(12) Patent Application Publication
(10) Pub. No.: US 2026/0184076 A1
(43) Pub. Date: Jul. 2, 2026

(54) NOZZLE PLATE, LIQUID DISCHARGE HEAD, AND IMAGE FORMING APPARATUS

(71) Applicant: Ryoji OKAMOTO, Kanagawa (JP)

(72) Inventor: Ryoji OKAMOTO, Kanagawa (JP)

(21) Appl. No.: 19/412,904

(22) Filed: Dec. 9, 2025

(30) Foreign Application Priority Data
Dec. 27, 2024 (JP) 2024-232375

(51) Int. Cl. B41J 2/14; B41J 2/16

(52) U.S. Cl. CPC B41J 2/1433; B41J 2/162; B41J 2/1623; B41J 2/164; B41J 2202/03

(57) ABSTRACT

A nozzle plate includes: a base material; a first film over the base material, the first film containing at least one of W, Mo, Ti, or Si, and at least one of C, N, or O; a second film over the first film, the second film including an oxide film containing Si; a water-repellent film over the second film; and a nozzle penetrating through the base material, the first film, the second film, and the water-repellent film in a discharge direction, the nozzle to discharge a liquid from the nozzle in the discharge direction.

### CROSS-REFERENCE TO RELATED APPLICATIONS

This patent application is based on and claims priority pursuant to 35 U.S.C. § 119(a) to Japanese Patent Application No. 2024-232375, filed on Dec. 27, 2024, in the Japan Patent Office, the entire disclosure of which is hereby incorporated by reference herein.

### BACKGROUND

### Technical Field

The present embodiment relates to a nozzle plate, a liquid discharge head, and an image forming apparatus.

### Related Art

In a nozzle plate provided in a liquid discharge head, a water-repellent film is provided on the surface of the nozzle plate to improve the droplet wiping property by a wiping member at the time of maintenance.

The surface of the nozzle plate on which the water-repellent film is formed preferably has durability against water-repellent deterioration due to physical wear, scratches, or the like caused by repeated wiping operations of the wiping member, and chemical deterioration due to alkaline ink (liquid).

### SUMMARY

The present disclosure described herein provides a nozzle plate including: a base material; a first film over the base material, the first film containing at least one of W, Mo, Ti, or Si, and at least one of C, N, or O; a second film over the first film, the second film including an oxide film containing Si; a water-repellent film over the second film; and a nozzle penetrating through the base material, the first film, the second film, and the water-repellent film in a discharge direction, the nozzle to discharge a liquid from the nozzle in the discharge direction.

The present disclosure described herein further provides a nozzle plate including a base material; a first film over the base material, the first film containing contains Cr and at least one of C, N, or O; a second film over the first film, the second film including is an oxide film containing Si and a second transition metal or a third transition; a water-repellent film over the second film; and a nozzle penetrating through the base material, the first film, the second film, and the water-repellent film in a discharge direction, the nozzle to discharge a liquid from the nozzle in the discharge direction, and the base material has an outer surface opposed to the first film, and the outer surface has a surface roughness Ra of 10 nm or less.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic side view illustrating an overall configuration of an image forming apparatus according to a first embodiment;

FIG. 2 is an explanatory plan view of a periphery of a carriage of the image forming apparatus illustrated in FIG. 1;

FIG. 3 is an explanatory cross-sectional view of a liquid discharge head along a longitudinal direction of a liquid chamber;

FIG. 4 is an explanatory cross-sectional view of the liquid discharge head of FIG. 3 in a lateral direction of the liquid chamber (a direction in which nozzles are arranged);

FIG. 5 is a view illustrating a configuration of a nozzle plate according to the present embodiment;

FIG. 6 is a graph illustrating a relationship between the film thickness of a first film and the contact angle with ink; and

FIG. 7 is a graph illustrating results of measuring contact angles before and after a wiping operation according to an example and comparative examples.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, the present embodiment will be described with reference to the drawings. Identical parts are given identical reference numerals and redundant descriptions are summarized or omitted accordingly.

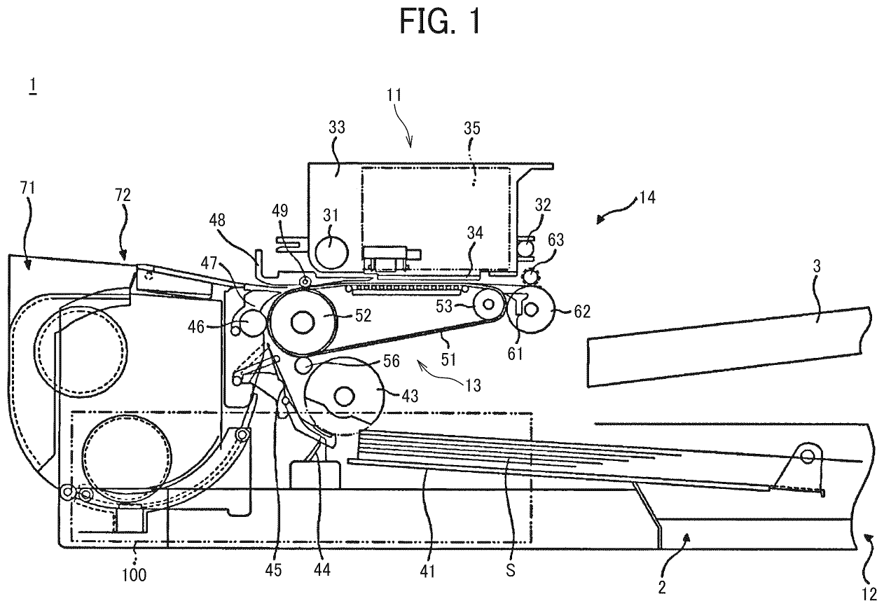

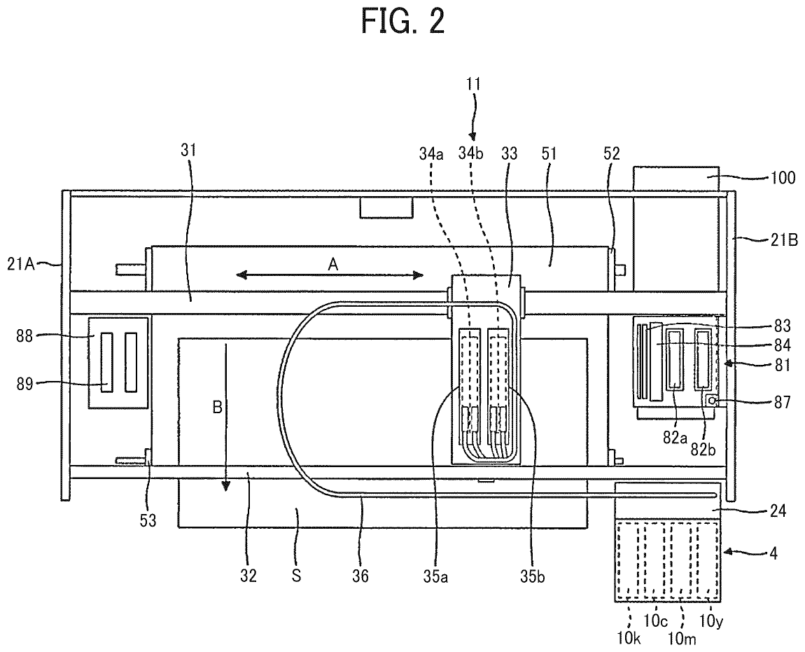

An image forming apparatus according to a first embodiment will be described with reference to FIGS. 1 and 2. FIG. 1 is a schematic side view illustrating an overall configuration of an image forming apparatus according to the first embodiment, and FIG. 2 is

an explanatory plan view of a periphery of a carriage of the image forming apparatus illustrated in FIG. 1.

This image forming apparatus is a serial type inkjet recording apparatus. An image forming apparatus 1 illustrated in FIGS. 1 and 2 mainly includes an image formation portion 11, a sheet feeding portion 12, a conveyance portion 13, a sheet ejection portion 14, a maintenance and recovery mechanism 81, and the like.

As illustrated in FIG. 2, in the image formation portion 11, side plates 21A and 21B are arranged on left and right-side surfaces of the image forming apparatus 1. Guide rods 31 and 32 are laterally bridged on the side plates 21A and 21B. A carriage 33 is slidably held in a main scanning direction A by the guide rods 31 and 32. The carriage 33 moves and scans in the carriage main scanning direction A indicated by arrows in FIG. 2 via a timing belt by a main scanning motor.

The carriage 33 includes recording heads 34a and 34b (referred to as “recording heads 34” when not distinguished) including a plurality of liquid discharge heads that discharges inks of respective colors: yellow (Y), magenta (M), cyan (C), and black (K). In each of the recording heads 34a and 34b, a nozzle row including a plurality of nozzles for discharging ink that is liquid is arranged in a sub-scanning direction orthogonal to the main scanning direction. The carriage 33 is mounted to face an ink discharging direction of the nozzle row downward.

Each of the recording heads 34 includes two nozzle rows. One nozzle row of the recording head 34a discharges the black (K) ink, and the other nozzle row discharges the cyan (C) ink. One nozzle row of the recording head 34b discharges the magenta (M) ink, and the other nozzle row discharges the yellow (Y) ink. As another configuration, a recording head including a nozzle row of each color in which a plurality of nozzles is arranged on one nozzle surface may be used.

The carriage 33 is equipped with sub-tanks 35a and 35b that supply the inks of the colors corresponding to the nozzle rows of the recording heads 34. The ink of each color (recording liquid) is replenished and supplied to the sub-tanks 35 from the ink cartridges (main tanks) 10y, 10m, 10c, and 10k of the colors detachably attached to a cartridge loading portion 4 through a supply tube 36 of each color by a supply pump unit 24.

Referring to FIG. 1, the sheet feeding portion 12 includes a sheet feeding tray 2 including a sheet stacking portion 41, a sheet feeding rolling element 43, a separation pad 44, a guide member 45, a counter roller 46, a conveyance guide 47, and a pressing member 48 including a leading end pressing rolling element 49. In a state where the separation pad 44 made of a material having a large friction coefficient is biased toward the sheet feeding rolling element 43 side while facing the sheet feeding rolling element 43, sheets S are separated and fed one by one from the sheet stacking portion 41. Then, the sheet S fed from the sheet feeding tray 2 is guided by the guide member 45, and is sent to the lower side of the recording heads 34 by the counter roller 46, the conveyance guide 47, and the pressing member 48 including the leading end pressing rolling element 49.

The conveyance portion 13 includes a conveyance belt 51, a conveyance roller 52, and a tension roller 53. The conveyance belt 51 electrostatically attracts the fed sheet S and conveys the sheet S at a position facing the recording heads 34. The conveyance belt 51 is an endless belt. The conveyance belt 51 is stretched between the conveyance roller 52 and the tension roller 53. The conveyance belt 51 circulates in a belt conveyance direction (sub-scanning direction) B of FIG. 2 when the conveyance roller 52 is rotationally driven at a timing by a sub-scanning motor.

A charging roller 56 is disposed as a charging device that charges the surface of the conveyance belt 51. The charging roller 56 is disposed to contact a surface layer of the conveyance belt 51 and rotate following the rotation of the conveyance belt 51.

As the sheet ejection portion 14 that ejects the sheet S recorded by the recording heads 34, a separation claw 61 that separates the sheet S from the conveyance belt 51, a sheet ejection roller 62, and a spur 63 that is a sheet ejection rolling element are provided, and a sheet ejection tray 3 is provided below the sheet ejection roller 62.

A double-sided unit 71 is detachably attached to a back surface portion of the apparatus body of the image forming apparatus 1. The double-sided unit 71 takes in the sheet S returned by the reverse rotation of the conveyance belt 51, reverses the sheet S, and feeds the sheet S between the counter roller 46 and the conveyance belt 51 again. An upper surface of the double-sided unit 71 is a manual paper feeding tray 72.

The maintenance and recovery mechanism 81 that maintains and recovers the state of the nozzles of the recording heads 34 is disposed in a non-printing area on one side in the scanning direction of the carriage 33. The maintenance and recovery mechanism 81 includes caps 82a and 82b, a wiper blade 83 as a wiping member, a dummy discharge receiver 84, a carriage lock 87, and the like. The caps 82a and 82b cap the nozzle surfaces of the recording heads 34a and 34b, respectively. The wiper blade 83 wipes the nozzle surfaces. The dummy discharge receiver 84 receives ink by dummy discharge. This dummy discharge is an operation of discharging ink that does not contribute to recording to discharge the thickened ink. The carriage lock 87 secures the position of the carriage 33. On the lower side of the maintenance and recovery mechanism 81 of the head, a waste liquid tank 100 that stores waste liquid generated by the maintenance and recovery operation is attached to be replaceable with respect to the apparatus body.

A dummy discharge receiver 88 is disposed in a non-printing area on the other side in the scanning direction of the carriage 33. The dummy discharge receiver 88 includes openings 89 along the nozzle row direction of the recording heads 34.

A printing operation in the image forming apparatus configured as described above will be described. The sheet S separated and fed one by one from the sheet feeding tray 2 and fed substantially vertically upward is guided by the guide member 45, sandwiched and conveyed between the conveyance belt 51 and the counter roller 46, and further guided at the leading end by the conveyance guide 47. Thereafter, the sheet S is pressed by the leading end pressing rolling element 49 against the conveyance belt 51, and the conveyance direction is changed by approximately 90°.

At this time, a voltage is applied to the charging roller 56 so that a positive output and a negative output are alternately repeated, and the charging roller 56 charges the conveyance belt 51 using a charging voltage pattern by an alternating current. When the sheet S is fed onto the charged conveyance belt 51, the sheet S is attracted to the conveyance belt 51, and the sheet S is conveyed in the sub-scanning direction by the circular movement of the conveyance belt 51.

Therefore, by driving the recording heads 34 according to an image signal while moving the carriage 33, the carriage 33 is moved to a position above the conveyance belt 51, and ink is discharged onto the sheet S being stopped to form an image for one row. After the sheet S is conveyed a predetermined amount by the conveyance belt 51, the carriage 33 performs image formation of the next row. When an image formation end signal or a signal indicating that the rear end of the sheet S has reached the recording area is received, the image formation operation of the carriage 33 is ended, and the sheet S is ejected to the sheet ejection tray 3.

When maintaining and recovering the nozzles of the recording heads 34, the carriage 33 is moved to a position facing the maintenance and recovery mechanism 81, which is the home position. The maintenance and recovery mechanism 81 performs the maintenance and recovery operation such as nozzle suction in which capping is performed by the caps 82a and 82b to perform suction from the nozzle, and a dummy discharge operation. With such operations, image formation by stable ink discharge can be performed.

In the image forming apparatus including such an inkjet recording apparatus, since a liquid discharge apparatus according to the present embodiment described below is mounted, high-quality recording on plain paper using a high-viscosity ink can be performed at high speed.

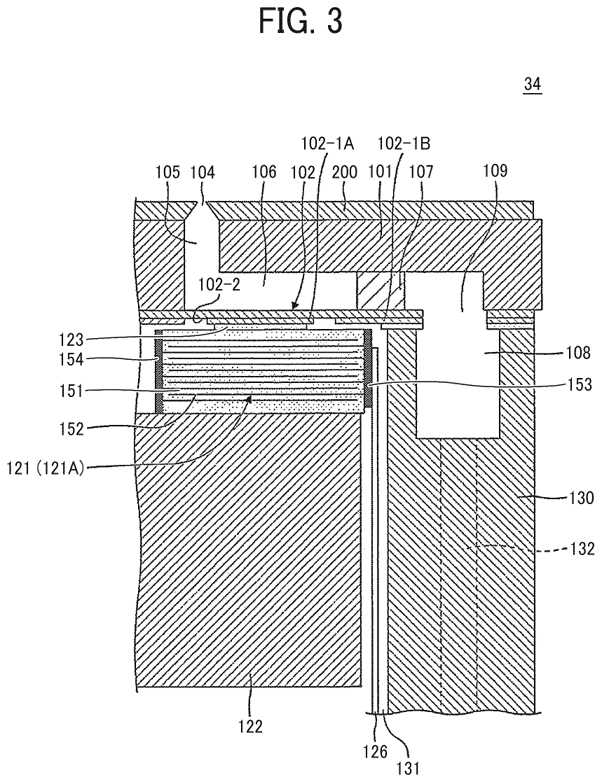

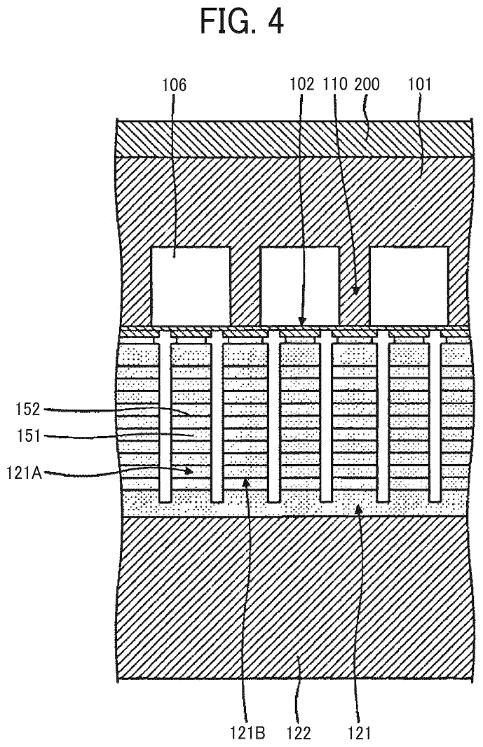

Next, an example of an internal configuration of the recording head (liquid discharge head) will be described with reference to FIGS. 3 and 4. FIG. 3 is an explanatory cross-sectional view of the liquid discharge head along a longitudinal direction of a liquid chamber, and FIG. 4 is an explanatory cross-sectional view of the liquid discharge head of FIG. 3 in a lateral direction of the liquid chamber (an arrangement direction of nozzles).

In the liquid discharge head (recording head 34), a channel plate 101, a diaphragm 102 joined to a lower surface of the channel plate 101, and a nozzle plate 200 joined to an upper surface of the channel plate 101 are joined and stacked. Thus, a nozzle 104 that discharges ink droplets (droplets), a nozzle communication path 105, a pressure chamber 106 (ink chamber) as a pressure generation chamber, a fluid resistance portion 107, a common liquid chamber 108, an ink supply path 109, and the like are formed.

The ink in the pressure chamber 106 is discharged from the nozzle 104 through the nozzle communication path 105, which is a flow path communicating with the nozzle. Thereafter, with the completion of the ink discharge, the ink pressure in the pressure chamber 106 decreases, and a negative pressure is generated in the pressure chamber 106 by the inertia of the ink flow and the discharge process of the drive pulse, and the processing proceeds to the ink filling process. At this time, the ink supplied from the ink tank (sub-tank 35) flows into the common liquid chamber 108, passes through the fluid resistance portion 107 from the common liquid chamber 108 through the ink supply path 109, and is supplied into the pressure chamber 106.

The liquid discharge head is a pressure generation device (actuator) that deforms the diaphragm 102 to pressurize the ink in the pressure chamber 106. The liquid discharge head includes two (only one row is illustrated in FIG. 3) stacked piezoelectric members 121 that function as electromechanical transducer elements.

The piezoelectric member 121 is bonded and secured, and a base substrate 122 constituting an actuator unit together with the piezoelectric member 121 and the like is disposed. In the piezoelectric member 121, a plurality of piezoelectric elements 121A and a plurality of strut members 121B are formed by forming grooves by slit processing causing no division. In this example, the piezoelectric elements 121A are driven piezoelectric element columns to which a driving waveform is applied, and the strut members 121B are non-driven piezoelectric element columns to which a driving waveform is not applied.

An end surface electrode of one end surface of the piezoelectric member 121 is divided by dicing processing by half cutting to form a comb-shaped individual electrode 154, and an end surface electrode of the other end surface is not divided due to restriction by processing such as a notch and forms a common electrode 153 electrically connected to all the piezoelectric elements 121A. The common electrode 153 is connected to a ground (GND) electrode of an FPC cable 126 by being provided along an electrode layer provided at an end of the piezoelectric element 121A. A head driver (driver IC) is implemented on the FPC cable 126, and controls application of a drive voltage to the common electrode 153 of the piezoelectric element 121A.

The peripheral edge portion of the diaphragm 102 is joined to a frame member 130. The frame member 130 includes a penetrating portion 131 that houses an actuator unit including the piezoelectric member 121, the base substrate 122, and the like, a recess that functions as the common liquid chamber 108, and an ink supply hole 132 that is a supply port for supplying ink from the outside to the common liquid chamber 108.

In the channel plate 101, a groove to be the ink supply path 109, the fluid resistance portion 107, and the pressure chamber 106, and a through-hole to be the nozzle communication path 105 at a position with respect to the nozzle 104 are formed by patterning by an etching method using a silicon single crystal substrate. A portion left by the etching becomes a partition wall 110 of the pressure chamber 106. The liquid discharge head (recording head 34) is provided with a portion that narrows the etching width, and this portion serves as the fluid resistance portion 107.

In the diaphragm 102, a thin portion (diaphragm portion 102-2) having a thickness of 2 to 10 μm and facilitating deformation and a thick portion (island-shaped protruding portion) 102-1A joined to the piezoelectric element 121A are formed at a portion corresponding to the pressure chamber 106. The island-shaped protruding portion 102-1A of the diaphragm 102, the common electrode 153 (movable portion) of the piezoelectric element 121A, and the diaphragm 102 and the frame member 130 are bonded to each other by patterning an adhesive layer 123 including a gap material. The diaphragm 102 is bonded to the frame member 130 via thick portion (island-shaped protruding portion) 102-1B and the adhesive layer 123.

Here, the diaphragm 102 is formed by nickel electroforming having a two-layer structure. In this case, the diaphragm portion 102-2 has a thickness of 3 μm and a width of 35 μm (one side).

The nozzle plate 200 forms the nozzle 104 having a diameter of about 10 to 30 μm corresponding to each pressure chamber 106 and is bonded to the channel plate 101 with an adhesive. The nozzle plate 200 uses metal such as SUS, ceramic, Si, resin, or the like as a member, and forms a water-repellent film on the outermost surface of a nozzle forming member with a necessary film interposed therebetween (details will be described later).

The piezoelectric member 121 is formed by alternately stacking a piezoelectric material 151 of lead zirconate titanate (PZT) having a thickness of 10 to 50 μm/per layer and an internal electrode 152 made of silver/palladium (AgPd) having a thickness of several μm/per layer. The internal electrode 152 is alternately electrically connected to the individual electrode 154 and the common electrode 153, which are end surface electrodes (external electrodes) on the end surfaces.

In such a liquid discharge head (recording head 34), for example, the voltage applied to the piezoelectric element 121A is lowered from a reference potential Ve (a pulse voltage or the like having a drive waveform of 10 to 50 V is applied) based on the drive voltage generated by a head driver, whereby the driven piezoelectric element 121A contracts. Therefore, when the diaphragm 102 descends and the volume of the pressure chamber 106 expands, the ink flows into the pressure chamber 106.

Thereafter, the voltage applied to the piezoelectric element 121A is increased to extend the piezoelectric element 121A, which is a driven piezoelectric element column, in a stacking direction, so that the diaphragm 102 is deformed in the nozzle 104 direction to contract the volume of the pressure chamber 106. By this operation, the ink in the pressure chamber 106 is pressurized, and the ink is discharged (ejected) from the nozzle 104.

Then, the diaphragm 102 is restored to the initial position by returning the voltage applied to the driven piezoelectric element 121A to the reference potential, and the pressure chamber 106 expands to generate a negative pressure. At this time, the pressure chamber 106 is filled with the ink from the common liquid chamber 108 through the fluid resistance portion 107. Therefore, after the vibration of the meniscus surface of the nozzle 104 is attenuated and stabilized, the processing proceeds to the next ink discharge operation.

A method for driving the head is not limited to the above-described method (pull-push discharging). A way of discharging changes depending on how a drive waveform is applied. For example, pull discharging or push discharging can be performed. An “individual liquid chamber” 106 includes a liquid chamber, a pressurizing chamber, a pressure chamber, a pressure chamber, an individual flow path, a pressure generation chamber, and the like.

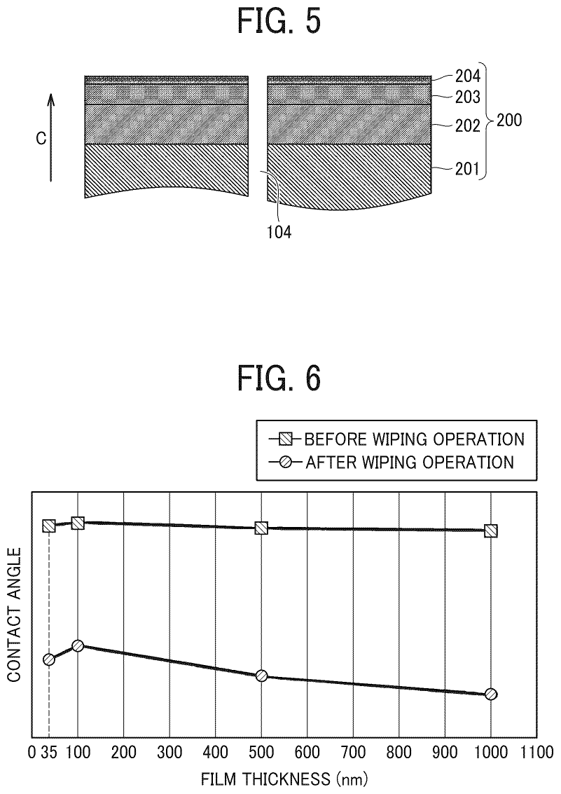

Next, the configuration of the nozzle plate according to the present embodiment will be described in more detail with reference to FIG. 5.

As illustrated in FIG. 5, a base material 201 in which the nozzle 104 is formed, a first film 202, a second film 203, and a water-repellent film 204 are formed on the nozzle plate 200 in this order from the bottom in FIG. 5. A downward to upward direction indicated by an arrow C in FIG. 5 is a liquid discharge direction (a downward to upward direction in FIG. 3). The first film 202, the second film 203, and the water-repellent film 204 are films formed so as to cover the surface of the base material 201 except for a portion where the nozzle end portion of the surface of the base material 201 is formed. However, another film may be provided between the base material 201, the first film 202, the second film 203, and the water-repellent film 204.

The base material 201 can be formed of metal such as SUS, ceramic, Si, resin, or the like, and SUS is used in the present embodiment. A nozzle having a diameter of about 10 to 30 μm is formed on the SUS substrate by pressing, etching, laser processing, or the like.

The first film 202 is a hard film containing at least one of W, Mo, Ti, or Si and at least one of C, N, or O and having high hardness. In the present embodiment, in particular, the first film 202 is formed of SiC, and the film thickness thereof is set to 100 nm. As a method for forming the first film 202, vapor deposition, ion plating, sputtering, MBE, electroplating, or the like can be applied.

The second film 203 is an oxide film containing Si. The second film 203 is an adhesive film that improves adhesion between the adjacent first film 202 and water-repellent film 204, particularly, with respect to the water-repellent film 204. By containing SiO in the second film 203, siloxane bonding can be performed with the water-repellent film 204, and the second film 203 and the water-repellent film 204 are firmly bonded. In particular, in the present embodiment, the second film 203 is formed of ZrSiOx containing Zr as second transition metal. As a film formation method of the second film 203, vapor deposition, ion plating, sputtering, MBE, electroplating, and the like can be applied as in the case of the first film.

The water-repellent film 204 can contain a silicone-based or fluorine-based compound. In the present embodiment, in particular, a fluorine-based water-repellent film 204 containing a silane coupling agent is used. As a method for forming the water-repellent film 204, dipping, vapor deposition, brush application, or the like can be applied.

By forming the water-repellent film 204, the ink droplets attached to the surface of the nozzle plate 200 can be efficiently wiped by the wiping operation. Therefore, it is possible to reduce adverse effects on ink discharge from the nozzle and image formation due to ink droplet adhesion in the nozzle and the periphery thereof.

However, there is a disadvantage that a force such as a frictional force is applied to the surface of the nozzle plate 200 by the wiping operation, leading to deterioration of water repellency of the surface of the nozzle plate 200. For example, the water-repellent film molecules of the water-repellent film 204 are cut, or the interfaces of the base material 201, the first film 202, the second film 203, and the water-repellent film 204 are broken, so that the water-repellency of the surface of the nozzle plate 200 deteriorates (hereinafter, this is referred to as physical water repellency deterioration). When the wiping force in the wiping operation is strong, discharge bending due to scratches on the surface of the base material 201 or deformation of the nozzle hole is caused (hereinafter, this is referred to as physical abrasion). In recent years, strongly alkaline inks are also used due to diversification of inks to be used. In this case, the interface between the water-repellent film 204 and the second film 203 or the siloxane bond present in the second film 203 is cut by the wiping operation, and the water-repellency of the surface of the nozzle plate 200 deteriorates (hereinafter, this is referred to as chemical water repellency deterioration).

In particular, in recent years, inks containing hard particles such as metal and ceramic, such as inks used for 3D printing and white inks, have been generally used. When such hard particles are pressed against the surface of the nozzle plate 200 during the wiping operation, a stronger frictional force is generated on the surface of the nozzle plate 200, and in particular, physical water repellency deterioration and physical abrasion become remarkable.

On the other hand, in the present embodiment, the first film 202 is formed as a hard film by containing at least one of W, Mo, Ti, or Si and at least one of C, N, or O. Thus, the hardness of the entire film formed on the surface of the base material 201 can be increased, and the penetration of ink particles such as hard particles into the water-repellent film 204 can be reduced. As a result, frictional force and shearing force generated between the ink particles and the water-repellent film 204 during the wiping operation can be reduced, and the physical water repellency deterioration and the physical abrasion can be reduced.

Since the second film 203 is an oxide film containing Si, a siloxane bond can be formed with respect to the water-repellent film 204 as described above. This makes it possible to improve the alkali resistance and suppress the chemical water repellency deterioration. As compared with a case where the second film 203 is not formed by the siloxane bond, that is, a case where the water-repellent film 204 is directly formed on the first film 202, the bond between the films can be strengthened, and the physical water repellency deterioration can be reduced. The second film 203 can strengthen the bonding between the base material 201 made of metal such as stainless steel and each film.

As described above, in the present embodiment, by providing the first film 202 and the second film 203 in this order between the base material 201 and the water-repellent film 204, it is possible to suppress the physical water repellency deterioration, physical abrasion, and chemical water repellency deterioration. That is, the durability of the surface of the nozzle plate 200 can be improved, and the water repellency can be maintained for a long period of time. Therefore, even when the ink uses hard particles, the water repellency is not impaired for a long period of time. As a result, it is possible to prevent adverse effects on ink discharge and image formation due to adhesion of ink droplets in the nozzle and the periphery thereof for a long period of time.

In the present embodiment, the hardness of the first film 202, the second film 203, and the water-repellent film 204 decreases toward the surface layer side in order from the hardest base material 201 side. Therefore, for example, as compared with a case where only the first film 202 and the water-repellent film 204 or only the second film 203 and the water-repellent film 204 are formed on the base material 201, the difference in hardness between adjacent films can be reduced. Therefore, each film can be easily fitted, and the connection of each film can be enhanced.

The second film 203 preferably contains a second transition metal or a third transition metal M like the second transition metal Zn of the present embodiment. The metal M can substitute Si without destroying the network in the Si—O network in the second film 203 due to its ionic radius, bonding force with oxygen, and the like. This makes it possible to obtain strong bondability to the water-repellent film 204 and alkali resistance. Therefore, the physical water repellency deterioration and the chemical water repellency deterioration can be reduced. In addition, in the second film 203, the bondability with the water-repellent film 204 and the alkali resistance depend on the ratio of the element amounts of Si and M, and there is a trade-off relationship. That is, since the second transition metal or the third transition metal M is less likely to be bonded to the second film 203 as compared with Si, when M is too large, the water-repellent film 204 becomes rough and cannot sufficiently repel the ink, and the water repellency thereof decreases. On the other hand, when M is too small, substitution of Si is not sufficient, and Si—O is easily disconnected. That is, the surface of the nozzle plate 200 cannot obtain sufficient alkali resistance, and the water repellency deteriorates early. Under such circumstances, the ratio of the second transition metal or the third transition metal M in the second film 203 is set to 1 to 20 at %. This makes it possible to achieve both good alkali resistance and water repellency of the surface of the nozzle plate. In order to obtain more ideal alkali resistance, the ratio of M is preferably set to a range of 10 to 20 at %.

A surface roughness Ra of the surface of the base material 201 on the first film 202 side is preferably 10 nm or less. When the surface of the base material 201 on which each film is formed has large irregularities, stress tends to be locally concentrated during the wiping operation, and physical damage or peeling of the water-repellent film tends to occur. Therefore, by setting the surface roughness Ra of the surface of the base material 201 on the first film 202 side to 10 nm or less, the stress generated during the wiping operation can be reduced, and the durability of the surface of the nozzle plate 200 can be improved, which is preferable.

The first film 202 may contain Cr instead of W, Mo, Ti, and Si. However, the first film 202 containing Cr is inferior in hardness to the first film 202 containing at least one of W, Mo, Ti, or Si. Therefore, the hardness of the surface of the nozzle plate 200 becomes insufficient particularly against the physical water repellency deterioration and the physical abrasion. In particular, when hard particles are used for the ink, the wiping force during the wiping operation becomes strong as described above, and the first film 202 containing Cr has insufficient hardness. However, when the second film 203 contains the second transition metal or the third transition metal M, as described above, strong bondability with the water-repellent film 204 can be achieved, and durability against the physical water repellency deterioration and the physical abrasion can be improved. In addition, by setting the surface roughness Ra of the surface of the base material 201 on the first film 202 side to 10 nm or less, the durability of the surface of the nozzle plate 200 can be improved as described above, and the low hardness of the first film 202 can be compensated for. Therefore, by combining the first film 202 containing Cr and at least one of C, N, or O, and the second film 203 that is an oxide film containing Si and the second transition metal or the third transition metal M, sufficient durability of the surface of the nozzle plate 200 can be obtained, and even when hard particles are used for the ink, the physical water repellency deterioration and the physical abrasion can be reduced.

In a case where Cr is contained in the first film 202, it is necessary to manage manufacturing conditions such as a manufacturing environment so as not to generate hexavalent chromium that is subject to ROHS regulation, and there is a case where the manufacturing conditions of the first film 202 become strict or the cost increases. Hexavalent chromium is generated when a chromium compound is oxidized by reacting with oxygen at a high temperature or in an acidic environment in the process of manufacturing the first film 202. For example, when Cr is formed into a film by sputtering, vapor deposition, or the like at the time of forming the first film 202, there is a possibility that a target material and a precursor are oxidized by being exposed to impurities (oxygen, moisture, and the like) or by being oxidized after the film formation of the first film 202, hexavalent chromium is generated. When the second film 203 including an oxide film such as SiO₂ or ZrSiO is formed on the first film 202 containing Cr, Cr may be oxidized to generate hexavalent chromium. By forming the first film 202 as a film not containing Cr but containing at least one of W, Mo, Ti, or Si as in the present embodiment, such hexavalent chromium can be prevented from being generated, and the manufacturing conditions for generating each film on the base material 201 including the first film 202 can be improved.

In the present embodiment, SUS is used as the material of the base material 201. SUS is preferable because it is superior to other materials in workability, cost, and ink resistance. By forming the base material 201 from a metal material such as SUS, it is possible to improve liquid contact property with respect to various kinds of droplets, which is also preferable in this respect. The liquid contact property as used herein refers to a property that the base material 201 is not dissolved or swollen by contact of droplets. On the other hand, when SUS is used as the material of the base material 201, the surface roughness Ra tends to be large, and for example, Ra is as large as about several 100 nm, so that stress concentration in the wiping operation tends to occur. Therefore, it is preferable to apply the film configuration of the present embodiment to the base material 201 made of SUS to improve the durability of the surface of the nozzle plate 200 and suppress the physical water repellency deterioration and the physical abrasion.

As in the present embodiment, the first film 202 preferably contains SiC. SiC has a higher hardness than other combinations that can be used for the first film 202. The first film 202 containing SiC is oxidized to form thin SiO₂ on the surface, and the bondability with SiO contained in the second film 203 is improved. Therefore, the bondability between the first film 202 and the second film 203 can be enhanced, and the durability of the surface of the nozzle plate 200 can be further improved.

It is preferable to use a film containing fluorine as the water-repellent film 204 because the contact angle with the ink can be increased and the water repellency can be enhanced.

The water-repellent film 204 preferably contains a silane coupling agent. As a result, a siloxane bond is easily formed between the second film 203 and the water-repellent film 204, and the bonding strength between the second film 203 and the water-repellent film 204 can be increased.

The thickness of the first film 202 is preferably 30 nm or more and 300 nm or less. In consideration of variations in film formation of the first film 202, it is preferable to set the thickness to 30 nm or more to secure the quality. By setting the thickness of the first film 202 to 300 nm or less, the contact angle with the ink can be set to a predetermined angle or more, which is preferable.

FIG. 6 is a graph illustrating a relationship between the film thickness of the first film 202 and the contact angle with ink. The configuration of the present embodiment described above is adopted as the configuration of the nozzle plate. In FIG. 6, the contact angle before

and after the wiping operation is measured for each sample in which only the film thickness is changed.

As illustrated in FIG. 6, the contact angle becomes the largest when the film thickness of the first film 202 is 100 nm, and the contact angle becomes smaller as the film thickness becomes larger. In a range of 300 nm or less, a contact angle at which only good water repellency is exhibited can be obtained. Therefore, the film thickness of the first film 202 is preferably set to 300 nm or less.

When the film thickness of the first film 202 is 100 nm or less, adhesion of each film to the base material 201 can be secured, and lift-off of the second film 203 and the water-repellent film 204 can be reduced, which is preferable. When the first film 202 was formed on the base material 201 of a Si wafer, film floating and film peeling were remarkably prevented particularly at 100 nm or less. Therefore, the thickness of the first film 202 is more preferably 30 nm or more and 100 nm or less. When the film thickness of the first film 202 is in a range of 30 nm or more and 50 nm or less, a change in color due to film formation variation is reduced, and a dark blue film can be stably formed, and therefore the film is particularly preferable because it is excellent in appearance quality.

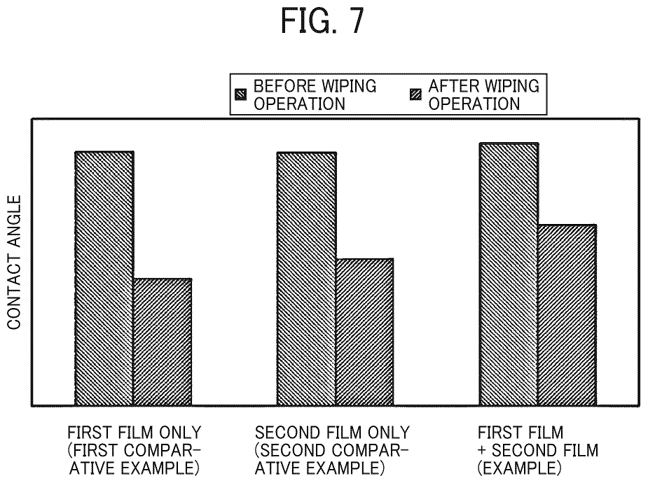

FIG. 7 is a graph illustrating an effect obtained by providing the first film 202 and the second film 203 and is a graph illustrating a result of measuring the contact angles before and after the wiping operation according to an example and comparative examples. FIG. 7 illustrates a case where only the first film 202 is provided between the base material 201 and the water-repellent film 204 (first comparative example), a case where only the second film 203 is provided (second comparative example), and a case where both the first film 202 and the second film 203 are provided (example).

The above embodiment is adopted for the configuration of the base material 201 and each film. Specifically, the base material 201 is made of SUS, the first film 202 has a film thickness of 100 nm and contains SiC, the second film 203 is a Si oxide film containing 10 at % of Zr, and a fluorine-based water-repellent film containing a silane coupling agent is adopted as the water-repellent film 204. The first film is formed by ion plating, the second film is formed by sputtering, and the water-repellent film is formed by vacuum vapor deposition.

As illustrated in FIG. 7, after the wiping operation, the contact angle of the example is larger than those of the first comparative example and the second comparative example. In the first comparative example in which only the first film 202 is provided, it is considered that a siloxane bond cannot be formed with respect to the water-repellent film 204, and the physical durability and alkali resistance of the surface of the nozzle plate 200 are insufficient. Therefore, the physical water repellency deterioration, physical abrasion, and chemical water repellency deterioration cannot be sufficiently reduced, and the contact angle is small. In the second comparative example in which only the second film 203 is provided, the hardness of the entire film is not sufficient, so that the physical water repellency deterioration and the physical abrasion cannot be sufficiently reduced, and the contact angle is small. As described above, by providing the first film 202 and the second film 203 of the present embodiment, it can be seen that the surface of the nozzle plate 200 has sufficient durability against the physical water repellency deterioration, physical abrasion, and chemical water repellency deterioration, and a large contact angle can be maintained even after the wiping operation.

The hardness of the first film 202 is preferably 16 GPa or more. As a result, the hardness of each film formed on the surface of the nozzle plate 200 as described above can be sufficiently increased, and sufficient durability of the surface of the nozzle plate 200 can be secured. The hardness of the first film 202 is hardness in a state where the first film 202 is formed on the base material 201.

Measurement conditions for measuring the hardness of the first film 202 of the present embodiment will be described below. Testing was performed in a state where the first film 202 was formed on the base material 201 described below, and the first film 202 was the same as that used in the experiment of FIG. 7.

### Test Conditions

Test method: Nanoindenter Test
Apparatus: Nanoindenter G200 manufactured by TOYO Corporation
Measurement method: Continuous rigidity measurement
Head: DCM head
Indenter: Berkovich
Drift rate: 0.3 nm/s
Indentation depth: 70 to 100 nm
Base material: Si wafer <100>
Allowable drift rate: 0.3 nm/s
Indentation depth upper limit: 1000 nm
Excitation frequency: 75 Hz
Amplitude of displacement: 1 nm
Percent to Unload: 90%
Strain rate: 0.05 l/s
Poisson's ratio: 0.3

As a result of performing the test on samples of N=19 under the above conditions, the average value of the hardness was 18.3 GPA and 3σ=2.2 GPa. Then, as in the embodiment of FIG. 7 described above, it is found that the entire film has sufficient hardness by the first film 202 of the present embodiment, and a sufficient contact angle can be maintained even after the wiping operation. From the above, it can be seen that the hardness of the first film 202 of the present embodiment, that is, the hardness is 16 GPa or more, whereby sufficient durability of the surface of the nozzle plate 200 against the physical water repellency deterioration and the physical abrasion during the wiping operation can be secured.

Although the present embodiment has been described above, the present embodiment is not limited to the above-described embodiment, and various modifications can be made without departing from the gist of the present embodiment.

In the present application, discharged liquid is not limited to a particular liquid if the liquid has a viscosity or surface tension to be discharged from a head. However, preferably, the viscosity of the liquid is not greater than 30 mPa·s under ordinary temperature and ordinary pressure or by heating or cooling. More specifically, examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

The term “liquid” includes not only ink but also paint, a pretreatment liquid, a binder, and an overcoat liquid.

Examples of the pressure generation device of the present embodiment include a piezoelectric actuator (a stacked piezoelectric element or a thin-film piezoelectric element), a thermal actuator that employs an electrothermal transducer element, such as a thermal resistor, and an electrostatic actuator including a diaphragm and opposed electrodes.

The “liquid discharge unit” is an assembly of parts relating to liquid discharge. The term “liquid discharge device” represents a structure including the head and a functional part(s) or unit(s) combined to the head to form a single unit. For example, the “liquid discharge unit” includes a combination of the liquid discharge head with at least one of a head tank, a carriage, a supply mechanism, a maintenance and recovery mechanism, a main scanning movement mechanism, or a liquid circulation apparatus.

Examples of the “single unit” include a combination in which the head and one or more functional parts and units are secured to each other through, e.g., fastening, bonding, or engaging, and a combination in which one of the head and the functional parts and units is movably held by another. The liquid discharge head and the functional part(s) or mechanism(s) may be detachably attached to each other.

For example, the liquid discharge head and the head tank may form the liquid discharge unit as a single unit. The liquid discharge head and the head tank may be integrated by being coupled with each other via a tube or the like. A unit including a filter may be added at a position between the head tank and the liquid discharge head of the liquid discharge unit.

The liquid discharge head and the carriage may be formed into a single unit as the liquid discharge unit.

The liquid discharge head is movably held on the guide member that constitutes a part of the scanning movement mechanism. Thus, the liquid discharge head and the scanning movement mechanism may be formed into a single unit to be the liquid discharge unit. The liquid discharge head, the carriage, and the main scanning movement mechanism may form a single unit.

A cap member that forms a part of the maintenance and recovery mechanism may be secured to the carriage mounting the liquid discharge head so that the liquid discharge head, the carriage, and the maintenance and recovery mechanism are formed into a single unit as the liquid discharge unit.

The liquid discharge unit may include a tube coupled to the head tank or the liquid discharge head mounting a channel part so that the liquid discharge head and the supply mechanism form a single unit. A liquid in a liquid reservoir source is supplied to the liquid discharge head through this tube.

The main scanning movement mechanism may include a guide member. The supply mechanism includes a tube(s) or a loading portion.

Here, the “liquid discharge unit” is described in a combined manner with the liquid discharge head, and the “liquid discharge unit” also includes those in which a head module or a head unit including the liquid discharge head described above with the functional parts or mechanisms described above are formed into a single unit.

The term “liquid discharge apparatus” includes an apparatus that includes the liquid discharge head, the liquid discharge unit, the head module, the head unit, and the like, and discharges liquid by driving the liquid discharge head.

The liquid discharge apparatus includes, in addition to apparatuses to discharge liquid to an object on which liquid can be attached, apparatuses to discharge the liquid into gas (air) or liquid.

The “liquid discharge apparatus” may include a device regarding feeding, conveyance, and paper ejection of an object on which liquid can be attached, a pretreatment apparatus, and a posttreatment apparatus.

The “liquid discharge apparatus” may be, for example, an image forming apparatus to form an image on a sheet by discharging ink, or a three-dimensional fabrication apparatus to discharge a fabrication liquid to a powder layer in which powder material is formed in layers to form a three-dimensional fabrication object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “object on which liquid can be attached” represents an object on which liquid can be at least temporarily attached, an object on which liquid is attached and fixed, or an object into which liquid is attached and permeates. The object on which liquid can be attached is a recording medium in the above embodiment. Examples include recording media, such as paper sheet, recording paper, recording sheet of paper, film, and cloth, electronic component, such as electronic substrate and piezoelectric element, and media, such as powder layer, organ model, and testing cell. The “object on which liquid can be attached” includes any object on which liquid can be attached, unless particularly limited.

Examples of the material of the “object on which liquid can be attached” may be any materials on which liquid can be attached even temporarily, such as paper, thread, fiber, fabric, leather, metal, plastic, glass, wood, and ceramic.

Examples of the “liquid discharge apparatus” further include a treatment liquid applying apparatus that discharges a treatment liquid onto a sheet to apply the treatment liquid to the surface of the sheet for the purpose of modifying the surface of the sheet, and an ejection granulating apparatus that ejects a composition liquid in which a raw material is dispersed in a solution through a nozzle to granulate fine particles of the raw material.

The terms of image formation, recording, printing, image printing, and fabricating used in the present application may be used synonymously with each other.

A nozzle plate includes: a base material; a first film over the base material, the first film containing at least one of W, Mo, Ti, or Si, and at least one of C, N, or O; a second film over the first film, the second film including an oxide film containing Si; a water-repellent film over the second film; and a nozzle penetrating through the base material, the first film, the second film, and the water-repellent film in a discharge direction, the nozzle to discharge a liquid from the nozzle in the discharge direction. The base material has a surface having a surface roughness Ra of 10 nm or less. The surface is opposed to the first film.

The first film contains SiC. The second film contains a second transition metal or a third transition metal, and the second film has the second transition metal or the third transition metal in a ratio of 1 to 20 at %. The second film has the second transition metal or the third

transition metal in a ratio of 10 to 20 at %. The water-repellent film contains a silane coupling agent. The water-repellent film contains fluorine. The first film has a thickness of 30 nm or more and 300 nm or less. The first film has a thickness of 30 nm or more and 100 nm or less. The first film has a thickness of 30 nm or more and 50 nm or less. The first film has a hardness of 16 GPa or more.

A nozzle plate includes: a base material; a first film over the base material, the first film containing contains Cr and at least one of C, N, or O; a second film over the first film, the second film including is an oxide film containing Si and a second transition metal or a third transition; a water-repellent film over the second film; and a nozzle penetrating through the base material, the first film, the second film, and the water-repellent film in a discharge direction, the nozzle to discharge a liquid from the nozzle in the discharge direction, wherein the base material has an outer surface opposed to the first film, and the outer surface has a surface roughness Ra of 10 nm or less. A liquid discharge head includes the nozzle plate. An image forming apparatus includes the liquid discharge head.

According to the present embodiment, the durability of the surface of the nozzle plate can be improved.

Aspects of the present embodiment are, for example, as follows.

Aspect 1

According to Aspect 1, a nozzle plate includes a nozzle that discharges liquid,
wherein a base material in which the nozzle is formed, a first film, a second film, and a water-repellent film are formed in this order from an upstream side to a downstream side in a liquid discharge direction from the nozzle,
the first film contains at least one of W, Mo, Ti, or Si, and at least one of C, N, or O, and
the second film is an oxide film containing Si.

Aspect 2

According to Aspect 2, in the nozzle plate of Aspect 1, a surface of the base material on a first film side has a surface roughness Ra of 10 nm or less.

Aspect 3

According to Aspect 3, in the nozzle plate of Aspect 1 or 2, the first film contains SiC.

Aspect 4

According to Aspect 4, in the nozzle plate of any of Aspects 1 to 3, the second film contains a second transition metal or a third transition metal, and a ratio of the second transition metal or the third transition metal in the second film is 1 to 20 at %.

Aspect 5

According to Aspect 5, in the nozzle plate of Aspect 4, the ratio of the second transition metal or the third transition metal in the second film is 10 to 20 at %.

Aspect 6

According to Aspect 6, in the nozzle plate of any of Aspects 1 to 5, the water-repellent film contains a silane coupling agent.

Aspect 7

According to Aspect 7, in the nozzle plate of any of Aspects 1 to 6, the water-repellent film contains fluorine.

Aspect 8

According to Aspect 8, in the nozzle plate of any of Aspects 1 to 7, a thickness of the first film is 30 nm or more and 300 nm or less.

Aspect 9

According to Aspect 9, in the nozzle plate of any of Aspects 1 to 7, a thickness of the first film is 30 nm or more and 100 nm or less.

Aspect 10

According to Aspect 10, in the nozzle plate of any of Aspects 1 to 7, a thickness of the first film is 30 nm or more and 50 nm or less.

Aspect 11

According to Aspect 11, in the nozzle plate of any of Aspects 1 to 10, a hardness of the first film on the base material is 16 GPa or more.

Aspect 12

According to Aspect 12, a nozzle plate includes a nozzle that discharges liquid,
wherein a base material in which the nozzle is formed, a first film, a second film, and a water-repellent film are formed in this order from an upstream side to a downstream side in a liquid discharge direction from the nozzle,
the first film contains Cr and at least one of C, N, or O,
the second film is an oxide film containing Si and a second transition metal or a third transition metal, and
a surface of the base material on a first film side has a surface roughness Ra of 10 nm or less.

Aspect 13

According to Aspect 13, in the nozzle plate of Aspect 12, the second film contains a second transition metal or a third transition metal, and a ratio of the second transition metal or the third transition metal in the second film is 1 to 20 at %.

Aspect 14

According to Aspect 14, in the nozzle plate of Aspect 13, the ratio of the second transition metal or the third transition metal in the second film is 10 to 20 at %.

Aspect 15

According to Aspect 15, in the nozzle plate of any of Aspects 12 to 14, the water-repellent film contains a silane coupling agent.

Aspect 16

According to Aspect 16, in the nozzle plate of any of Aspects 12 to 15, the water-repellent film contains fluorine.

Aspect 17

According to Aspect 17, in the nozzle plate of any of Aspects 12 to 16, a thickness of the first film is 30 nm or more and 300 nm or less.

Aspect 18

According to Aspect 18, in the nozzle plate of any of Aspects 12 to 16, a thickness of the first film is 30 nm or more and 100 nm or less.

Aspect 19

According to Aspect 19, in the nozzle plate of any of Aspects 12 to 16, a thickness of the first film is 30 nm or more and 50 nm or less.

Aspect 20

According to Aspect 20, in the nozzle plate of any of Aspects 12 to 19, a hardness of the first film on the base material is 16 GPa or more.

Aspect 21

According to Aspect 21, a liquid discharge head includes the nozzle plate of any of Aspects 1 to 20.

Aspect 22

According to Aspect 22, an image forming apparatus includes the liquid discharge head of Aspect 21.

The above-described embodiments are illustrative and do not limit the present invention. Thus, numerous additional modifications and variations are possible considering the above teachings. For example, elements and/or features of different illustrative embodiments may be combined with each other and/or substituted for each other within the scope of the present invention.

1. A nozzle plate comprising:
a base material;
a first film over the base material, the first film containing at least one of W, Mo, Ti, or Si, and at least one of C, N, or O;
a second film over the first film, the second film including an oxide film containing Si;
a water-repellent film over the second film; and
a nozzle penetrating through the base material, the first film, the second film, and the water-repellent film in a discharge direction, the nozzle to discharge a liquid from the nozzle in the discharge direction.

2. The nozzle plate according to claim 1,
wherein the base material has a surface having a surface roughness Ra of 10 nm or less.

3. The nozzle plate according to claim 2,
wherein the surface is opposed to the first film.

4. The nozzle plate according to claim 1,
wherein the base material has a surface having a surface roughness Ra of 10 nm or less.

5. The nozzle plate according to claim 1,
wherein the first film contains SiC.

6. The nozzle plate according to claim 1,
wherein the second film contains a second transition metal or a third transition metal, and
the second film has the second transition metal or the third transition metal in a ratio of 1 to 20 at %.

7. The nozzle plate according to claim 6,
wherein the second film has the second transition metal or the third transition metal in a ratio of 10 to 20 at %.

8. The nozzle plate according to claim 1,
wherein the water-repellent film contains a silane coupling agent.

9. The nozzle plate according to claim 1,
wherein the water-repellent film contains fluorine.

10. The nozzle plate according to claim 1,
wherein the first film has a thickness of 30 nm or more and 300 nm or less.

11. The nozzle plate according to claim 1,
wherein the first film has a thickness of 30 nm or more and 100 nm or less.

12. The nozzle plate according to claim 1,
wherein the first film has a thickness of 30 nm or more and 50 nm or less.

13. The nozzle plate according to claim 1,
wherein the first film has a hardness of 16 GPa or more.

14. A nozzle plate comprising:
a base material;
a first film over the base material, the first film containing contains Cr and at least one of C, N, or O;
a second film over the first film, the second film including is an oxide film containing Si and a second transition metal or a third transition;
a water-repellent film over the second film; and
a nozzle penetrating through the base material, the first film, the second film, and the water-repellent film in a discharge direction, the nozzle to discharge a liquid from the nozzle in the discharge direction,
wherein the base material has an outer surface opposed to the first film, and
the outer surface has a surface roughness Ra of 10 nm or less.

15. A liquid discharge head comprising the nozzle plate according to claim 1.

16. An image forming apparatus comprising the liquid discharge head according to claim 15.
